(19) United States
(12) Patent Application Publication
(10) Pub. No.: US 2007/0024560 A1
(43) Pub. Date: Feb. 1, 2007

(54) Liquid Crystal Display Device and Driving Method Thereof

(75) Inventors: Man Sung Kim, Gyeonggi-do (KR); Kyung Yul Kim, Busan (KR)

Correspondence Address: PATENT LAW GROUP LLP, 2635 NORTH FIRST STREET, SUITE 223, SAN JOSE, CA, 95134, US

(73) Assignee: Samsung Electronics Co., LTD., Gyeonggi-do (KR)

(21) Appl. No.: 11/381,294

(22) Filed: May 2, 2006

(30) Foreign Application Priority Data
Aug. 1, 2005 (KR) 10-2005-0070199

(51) Int. Cl. G09G 3/36

(52) U.S. Cl. 345/94

(57) ABSTRACT

Disclosed is a liquid crystal display (LCD) device which is capable of minimizing deterioration in picture quality caused by a kickback voltage, and a driving method thereof. The LCD device includes an LCD panel having a plurality of liquid crystal cells to which a pixel voltage signal is supplied, and a compensating common voltage generator for generating different compensating common voltages according to a pixel voltage signal which is fed back from the LCD panel.

### CROSS-REFERENCE TO RELATED APPLICATION

This application claims priority to Korean Patent Application No. 2005-70199 filed on Aug. 1, 2005, the contents of which are hereby incorporated by reference in their entirety.

### BACKGROUND OF THE INVENTION

1. Field of the Invention

The present invention relates to a liquid crystal display (LCD) device and a driving method thereof, and more particularly, to an LCD device that is capable of minimizing deterioration in picture quality caused by a kickback voltage, and a driving method thereof.

2. Description of the Related Art

A typical LCD device displays images by controlling the light transmittance of a liquid crystal by an electric field. This LCD device includes an LCD panel in which a matrix of liquid crystal cells is arranged, and a driving circuit for driving the LCD panel.

The LCD panel includes, as illustrated in FIG. 1, a gate line GL, a data line DL crossing the gate line GL, and a thin film transistor (TFT) formed at an intersection of the gate line GL and the data line DL, for driving a liquid crystal cell Clc. The LCD panel also includes a storage capacitor Cst for maintaining the voltage of the liquid crystal cell Clc.

If a data voltage is applied to a pixel electrode of the liquid crystal cell Clc and a common voltage Vcom is applied to a common electrode thereof formed on an upper substrate, the arrangement of liquid crystal molecules is changed by the electric field applied to the liquid crystal layer and the liquid crystal cell Clc adjusts the amount of transmitted light or cuts off the light. A pixel voltage signal is supplied as a gamma voltage which is preset according to driving voltage characteristics of the liquid crystal cell Clc.

FIG. 2 illustrates a scan pulse SCP supplied to the gate line GL and a voltage Vlc charged to the liquid crystal cell Clc.

Referring to FIG. 2, the scan pulse SCP swings between a gate high voltage Vgh for turning on the TFT and a gate low voltage Vgl for turning off the TFT. While this scan pulse SCP is maintained at the gate high voltage Vgh, that is, during a scanning period, the liquid crystal cell Clc charges a pixel voltage signal Vdata supplied as a gamma voltage and maintains the charged voltage for a constant time as a voltage charged to the storage capacitor Cst.

If a voltage having the same polarity is continuously applied to the liquid crystal cell, a liquid crystal and a display image deteriorate. Therefore, an LCD device drives the liquid crystal cell by an AC (Alternative Current) pixel voltage of which polarity is periodically changed. A polarity of this pixel voltage signal is inverted every frame on the basis of a common voltage Vcom applied to a common electrode.

Meanwhile, a kickback voltage or feed-through voltage ΔVp generated due to a parasite capacitance of the TFT functions as a main factor degrading picture quality of the LCD device. The kickback voltage ΔVp is defined as the following equation (1):

$$Δ {V}_{p} = \frac{Cgs}{Clc + Cst + Cgs} ( Vgh - Vgl ) \qquad ( 1 )$$

where Cgs is a parasite capacitance between a gate terminal of the TFT connected to the gate line GL and a source terminal of the TFT connected to the pixel electrode, as indicated in FIG. 1.

By this kickback voltage, the pixel voltage signal applied to the pixel electrode of the liquid crystal cell varies and thus flicker and image sticking appear on the display image. For example, if a polarity of the pixel voltage signal is inverted with 60 Hz, a luminance difference occurs between an odd frame and an even frame due to the kickback voltage and a 30 Hz flicker appears on the display image. If the LCD device operates for a long time under such a state, a DC (Direct Current) offset is applied to the liquid crystal cell. Then voltage-transmittance characteristics of the liquid crystal cell are shifted and the image sticking occurs.

In order to compensate for the kickback voltage, the kickback voltage can be measured on the liquid crystal cells. However, since the kickback voltage does not have the same value on all the liquid crystal cells arranged in the LCD panel, it is not possible to optimize the kickback voltage compensation. This is because the gate high voltage Vgh applied to the TFTs varies according to a position from a gate driver due to an RC delay caused by the length of the wiring of the gate line GL and because an electrostatic capacitance of the liquid crystal cells varies according to a position from the data driver. Therefore, a test pad corresponding to the respective liquid crystal cells should be added in order to measure the kickback voltage varying according to the position of the LCD panel. However, it is physically impossible to add such test pads because there is no design margin in a typical LCD panel.

### SUMMARY OF THE INVENTION

It is therefore an object of the present invention to provide an LCD device which is capable of minimizing deterioration in picture quality caused by a kickback voltage, and a driving method thereof.

In accordance with an aspect of the present invention, there is provided an LCD device including an LCD panel having a plurality of liquid crystal cells to which a pixel voltage signal is supplied, and a compensating common voltage generator for generating different compensating common voltages according to a pixel voltage signal which is fed back from the LCD panel.

The compensating common voltage generator generates different compensating common voltages according to a difference between a common voltage and a positive pixel voltage signal and a difference between the common voltage and a negative pixel voltage signal.

The LCD device further includes a comparator for comparing a difference between the common voltage and the positive pixel voltage signal with a difference between the common voltage and the negative pixel voltage signal.

The LCD panel includes thin film transistors connected to the liquid crystal cells, gate lines and data lines connected to the thin film transistors, and a feedback line formed in parallel with at least the data lines or the gate lines, for feeding back a pixel voltage signal charged to the liquid crystal cells.

Alternatively, the LCD panel includes thin film transistors connected to the liquid crystal cells, gate lines and data lines connected to the thin film transistors, a dummy data line formed in parallel with the data lines, dummy thin film transistors connected to the dummy data line and the gate lines, dummy liquid crystal cells connected to the dummy thin film transistors, and a feedback line for feeding back a pixel voltage signal charged to the dummy liquid crystal cells.

Alternatively, the LCD panel includes thin film transistors connected to the liquid crystal cells, gate lines and data lines connected to the thin film transistors, a dummy gate line formed in parallel with the gate lines, dummy thin film transistors connected to the dummy gate line and the data lines, dummy liquid crystal cells connected to the dummy thin film transistors, and a feedback line for feeding back a pixel voltage signal charged to the dummy liquid crystal cells.

The dummy liquid crystal cells are overlapped with a black matrix.

The compensating common voltage generator includes a voltage divider for dividing a driving voltage, and an operational amplifier to which a divided driving voltage is applied. The dividing resistors include first and second resistors connected between a driving voltage source and a ground voltage source, and a variable resistor for adjusting a level of the compensating common voltage. The voltage divider provides the divided driving voltage.

Alternatively, the compensating common voltage generator includes a common voltage generator for generating a common voltage, a resistor group having a plurality of resistors connected to the common voltage generator where the resistor group generates a plurality of compensating common voltages having different voltage levels, and a selector for selecting one of the pluralities of compensating common voltages.

The LCD device further includes a gate integrated circuit for driving the gate lines, and a data integrated circuit for driving the data lines.

The feedback pixel voltage signal is applied to the comparator through a dummy terminal of at least one of the gate integrated circuit and data integrated circuit.

Alternatively the feedback pixel voltage signal is applied to the comparator through a dummy region of a tape carrier package in which at least one of the gate integrated circuit and data integrated circuit is packaged.

In accordance with another aspect of the present invention, there is provided a method for driving an LCD device, including the steps of feeding back a pixel voltage signal supplied to a liquid crystal cell, and generating different compensating common voltages according to the feedback pixel voltage signal.

The step of generating different compensating common voltages includes generating different compensating common voltages according to a difference between a common voltage supplied to the liquid crystal cell and a positive pixel voltage signal and a difference between the common voltage and a negative pixel voltage signal.

The step of feeding back a pixel voltage signal includes feeding back the pixel voltage signal through a feedback line formed in parallel with at least one of a data line and a gate line of a liquid crystal display panel.

Alternatively, the step of feeding back a pixel voltage signal includes providing a liquid crystal display panel having gate lines, data lines crossing the gate lines, a dummy data line formed in parallel with the data lines, dummy thin film transistors connected to the dummy data line and the gate lines, dummy liquid crystal cells connected to the dummy thin film transistors, and a feedback line connected to pixel electrodes of the dummy liquid crystal cells, and feeding back a pixel voltage signal charged to the dummy liquid crystal cells through the feedback line.

Alternatively, the step of feeding back a pixel voltage signal includes providing a liquid crystal display panel having gate lines, data lines crossing the gate lines, a dummy gate line formed in parallel with the gate lines, dummy thin film transistors connected to the data lines and the dummy gate line, dummy liquid crystal cells connected to the dummy thin film transistors, and a feedback line connected to pixel electrodes of the dummy liquid crystal cells, and feeding back a pixel voltage signal charged to the dummy liquid crystal cells through the feedback line.

The step of generating different compensating common voltages includes dividing a driving voltage by using a voltage divider circuit, and generating the compensating common voltages by applying the divided driving voltage to an operational amplifier, wherein voltage levels of the compensating common voltages are adjusted by a variable resistor contained in the voltage divider circuit.

Alternatively, the step of generating different compensating common voltages includes generating a common voltage by a common voltage generator, generating compensating common voltages having different voltage levels by using a plurality of resistors connected to an output terminal of the common voltage generator, and selecting any one of the compensating common voltages.

The step of feeding back a pixel voltage signal includes feeding back the pixel voltage signal through a dummy terminal of an integrated circuit for driving at least ones of the gate lines and data lines.

The step of feeding back a pixel voltage signal includes feeding back the pixel voltage signal through a dummy terminal of an integrated circuit packaged in any one of a substrate of the liquid crystal display panel and a tape carrier package.

The step of feeding back a pixel voltage signal includes feeding back the pixel voltage signal through a dummy region of a tape carrier package in which an integrated circuit for driving at least ones of the gate lines and data lines is packaged.

### BRIEF DESCRIPTION OF THE DRAWINGS

The above and other objects, features and advantages of the present invention will become more apparent from the following detailed description when taken in conjunction with the accompanying drawings in which:

FIG. 1 is a circuit diagram equivalently illustrating a unit pixel of a related LCD device;

FIG. 2 is a waveform diagram of a kickback voltage generated from the unit pixel shown in FIG. 1;

FIG. 3 is a block diagram of an LCD device according to a first embodiment of the present invention;

FIGS. 4A and 4B are detailed circuit diagrams of an LCD panel shown in FIG. 3;

FIG. 5 is a waveform diagram for describing the role of a comparator shown in FIG. 3;

FIGS. 6A to 6C are diagrams for describing a flow of a pixel voltage signal which is fed back from the LCD panel shown in FIG. 3;

FIG. 7 is a detailed circuit diagram of a compensating common voltage generator shown in FIG. 3;

FIGS. 8A and 8B are diagrams of a compensating common voltage generated in response to a comparison control signal generated from the comparator shown in FIG. 3;

FIG. 9 is a circuit diagram of an LCD panel of an LCD device according to a second embodiment of the present invention;

FIG. 10 is a circuit diagram illustrating another LCD panel of an LCD device according to the second embodiment of the present invention;

FIG. 11 is a circuit diagram of a compensating common voltage generator of an LCD device according to a third embodiment of the present invention; and

FIG. 12 is a flow chart of a driving method of an LCD device according to the present invention.

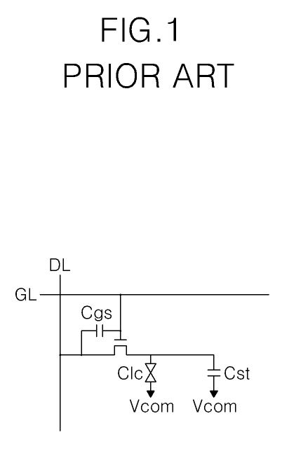

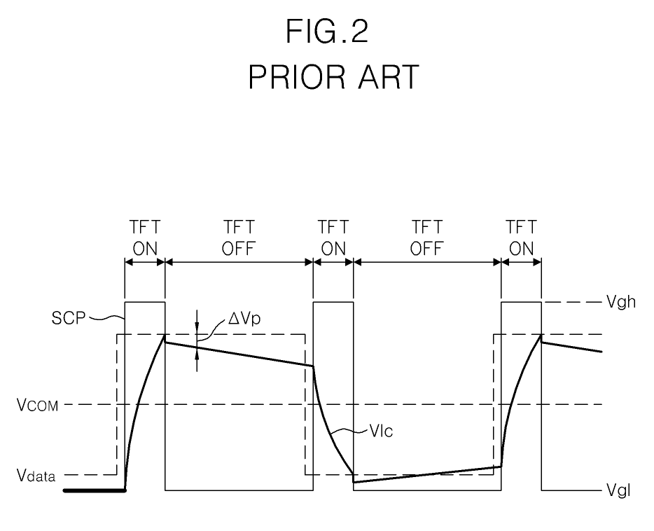

### DETAILED DESCRIPTION OF THE PREFERRED EMBODIMENT

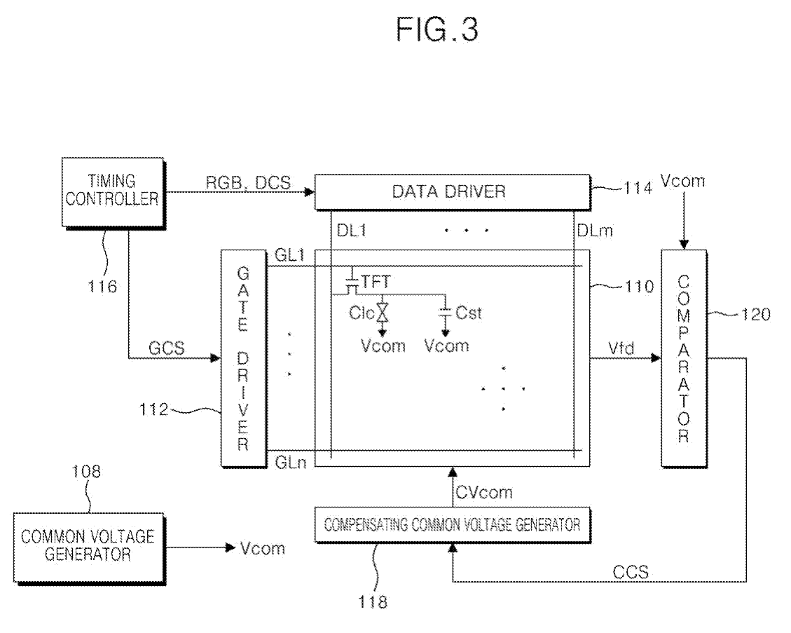

Preferred embodiments of the present invention will be described herein below with reference to FIG. 3 to FIG. 12.

FIG. 3 is a block diagram of an LCD device according to a first embodiment of the present invention.

Referring to FIG. 3, the LCD device includes an LCD panel 110, a data driver 114 for supplying a pixel voltage signal to data lines DLl to DLm of the LCD panel 110, a gate driver 112 for supplying a scan signal to gate lines GLl to GLn, a timing controller 116 for controlling the data driver 114 and the gate driver 112 by using a synchronization signal received from a system, a comparator 120 for comparing the pixel voltage signal which is fed back from the LCD panel 110 with a common voltage, and a compensating common voltage generator 118 for adjusting the common voltage according to an output result of the comparator 120.

The timing controller 116 rearranges digital video data RGB received from a graphic controller of the system and supplies the rearranged data to the data driver 114.

The timing controller 116 generates a gate control signal GCS for controlling the gate driver 112, and a data control signal DCS for controlling the data driver 114. The gate control signal GCS for controlling the gate driver 112 includes a gate start pulse GSP, a gate shift clock GSC and a gate output enable signal GOE. The data control signal DCS for controlling the data driver 114 includes a source start pulse SSP, a source shift clock SSC, a source output enable signal SOE and a polarity signal POL.

The data driver 114 converts the digital video data RGB into an analog gamma voltage corresponding to a gray level in response to the data control signal DCS received from the timing controller 116, and supplies the analog gamma voltage to the data lines DLl to DLm.

The gate driver 112 sequentially supplies the scan pulse to the gate lines GLl to GLn in response to the gate control signal GCS received from the timing controller 116. Thus the gate driver 112 makes thin film transistors TFT connected to the gate lines GLl to GLn be driven in the unit of gate lines.

The LCD panel 110 includes a plurality of liquid crystal cells Clc arranged in a matrix configuration at intersections of the data lines DLl to DLm and the gate lines GLl to GLn. Thin film transistors TFT connected to the respective liquid crystal cells Clc provide the liquid crystal cells Clc with the pixel voltage signal supplied through the data lines DLl to DLm in response to the scan signal supplied through the gate line.

Storage capacitors Cst are connected to the liquid crystal cells Clc. Each storage capacitor Cst is formed between a pixel electrode of the liquid crystal cell Clc and a preceding gate line or between the pixel electrode of the liquid crystal cell Clc and a storage line, thereby maintaining a voltage charged to the liquid crystal cell Clc at a constant level.

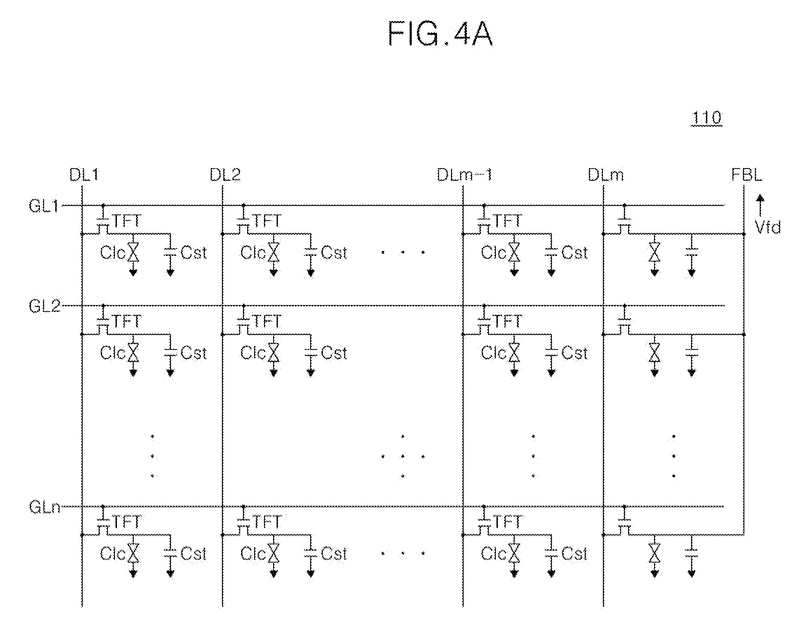

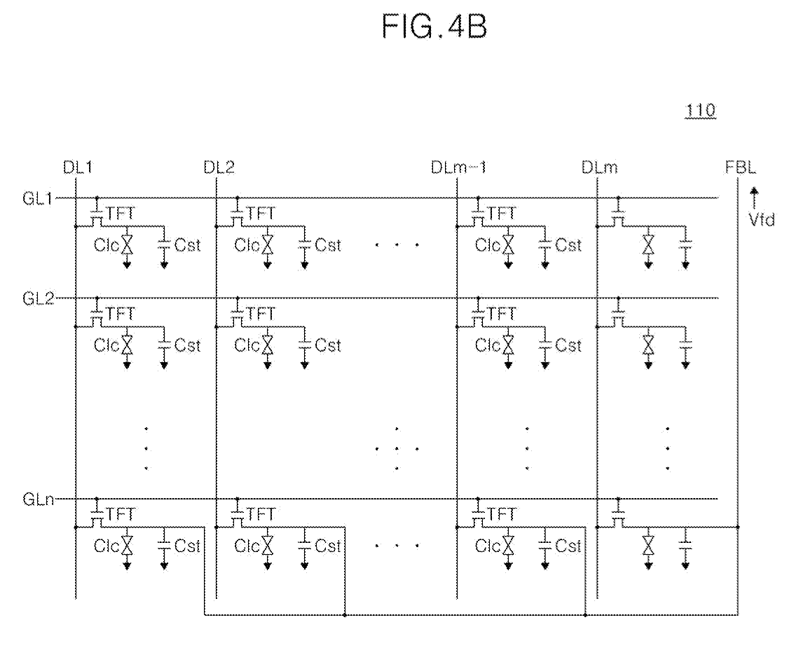

As shown in FIG. 4A or 4B, the LCD panel 110 includes at least one feedback line FBL for feeding back the pixel voltage signal supplied to the pixel electrode of the liquid crystal cell Clc to the comparator 120.

The feedback line FBL shown in FIG. 4A is connected to the pixel electrodes of the liquid crystal cells Clc to which the pixel voltage signal is supplied via the thin film transistors TFT from at least one data line.

The feedback line FBL shown in FIG. 4B is connected to the pixel electrodes of the liquid crystal cells Clc to which the pixel voltage signal is supplied via the thin film transistors TFT from the first to m-th data lines DLl to DLm.

The feedback line FBL may be formed of one, or two in order to feed back positive-polarity and negative-polarity pixel voltage signals, or the same number of data lines or gate lines. The feedback line FBL also may be formed of groups of gate lines or data lines.

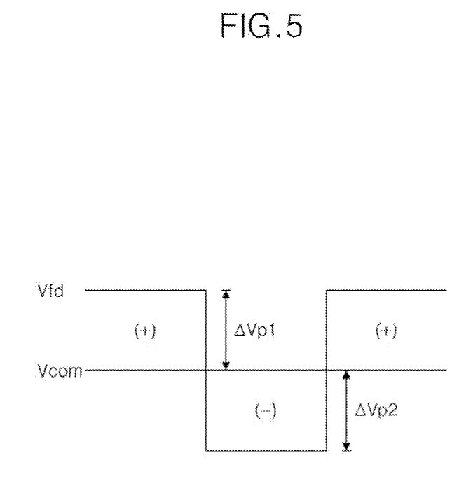

The comparator 120 compares difference voltages between a common voltage Vcom which is fed back from the common voltage generator 108 or the LCD panel 110 and positive/negative pixel voltage signal Vfd which is fed back through the feedback line FBL of the LCD panel 110. That is, as shown in FIG. 5, the comparator 120 compares a first difference voltage ΔVp1 between the common voltage Vcom and the positive pixel voltage signal with a second difference voltage ΔVp2 between the common voltage Vcom and the negative pixel voltage signal. Then the comparator 120 generates a comparison control signal CCS corresponding to a difference between the two difference voltages ΔVp1 and ΔVp2.

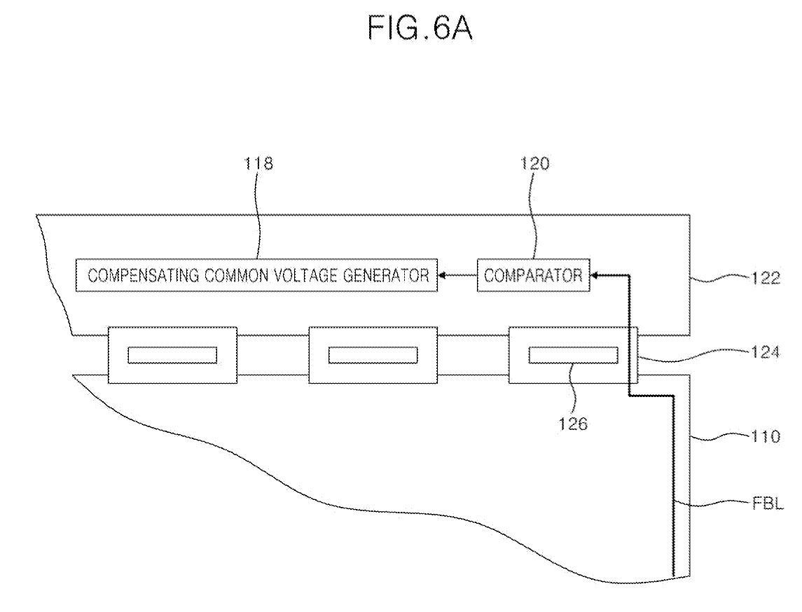

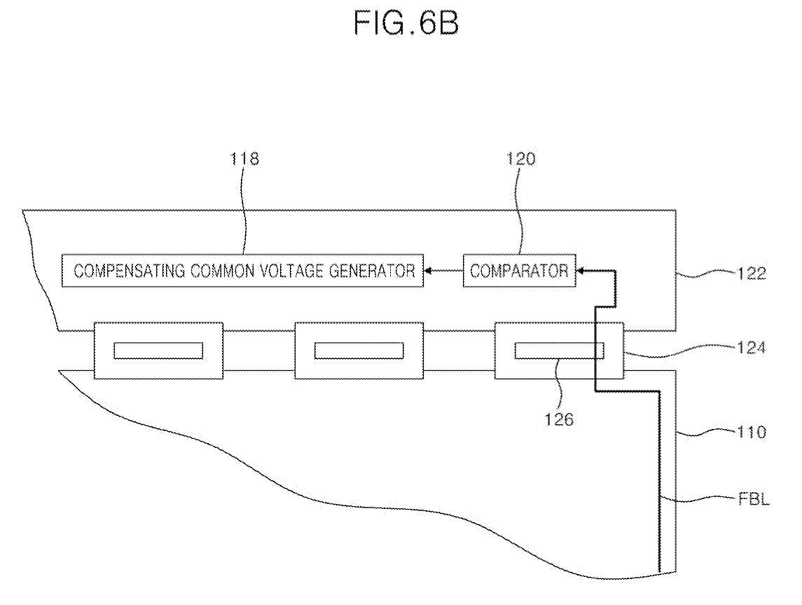

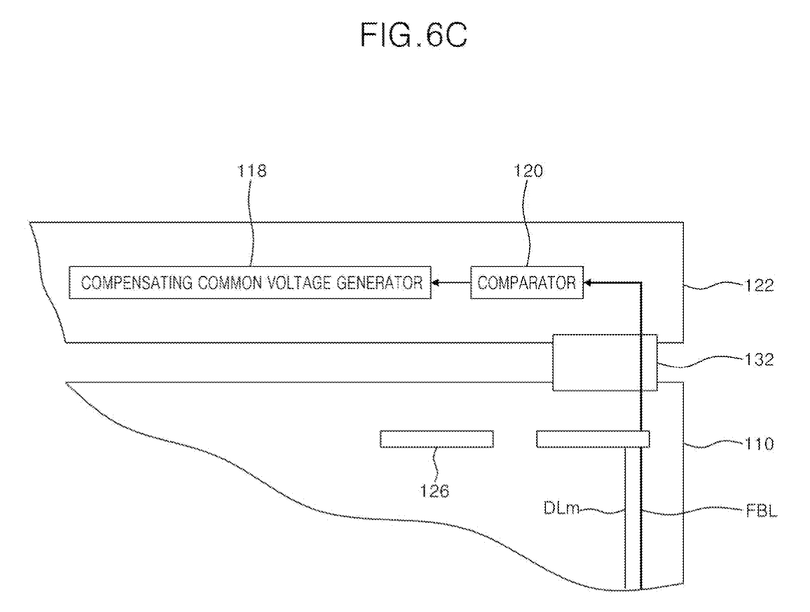

The feedback pixel voltage signal Vfd is applied, as shown in FIG. 6A, to the comparator 120 packaged on a printed circuit substrate 122 via the feedback line FBL of the LCD panel 110 and a dummy region of a tape carrier package 124 in which an integrated circuit 126 is packaged.

Alternatively, the feedback pixel signal Vfd is applied, as shown in FIG. 6B, to the comparator 120 packaged on the printed circuit substrate 122 via the feedback line FBL of the LCD panel 110, and a dummy terminal of the integrated circuit 126 packaged in the tape carrier package 124.

Moreover, the feedback pixel signal Vfd can be applied, as shown in FIG. 6C, to the comparator 120 packaged on the printed circuit substrate 122 via the feedback line FBL of the LCD panel 110, the dummy terminal of the integrated circuit 126 formed on the LCD panel 110, and the flexible printed circuit (FPC) 132.

The compensating common voltage generator 118 supplies to the LCD panel 110 a compensating common voltage CVcom of which voltage level is adjusted in response to the comparison control signal CCS when the first and second difference voltages ΔVp1 and ΔVp2 are judged to be different by the comparator 120.

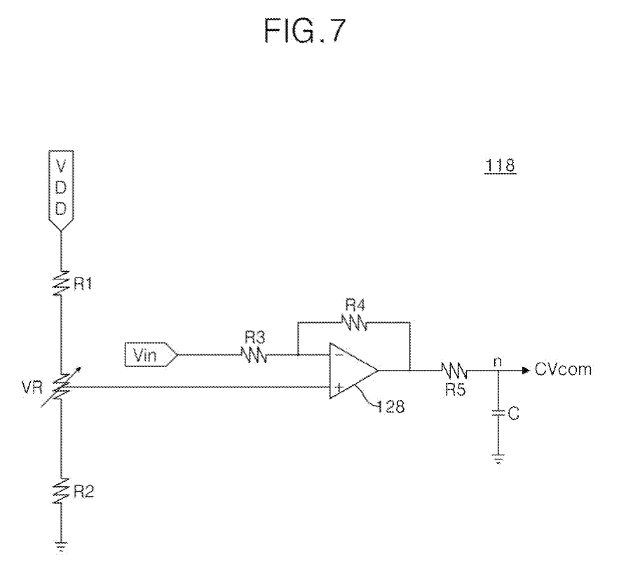

For this, the compensating common voltage generator 118 includes, as shown in FIG. 7, a first resistor R1, a variable resistor VR and a second resistor R2 connected between a driving voltage source VDD and a ground voltage source GND, an operational amplifier 128 to which a divided VDD voltage is applied, a fifth resistor R5 connected between an output terminal of the operational amplifier 128 and an output node n connected to an output terminal of the compensating common voltage generator 118, and a capacitor C connected between the output node n and the ground voltage source GND.

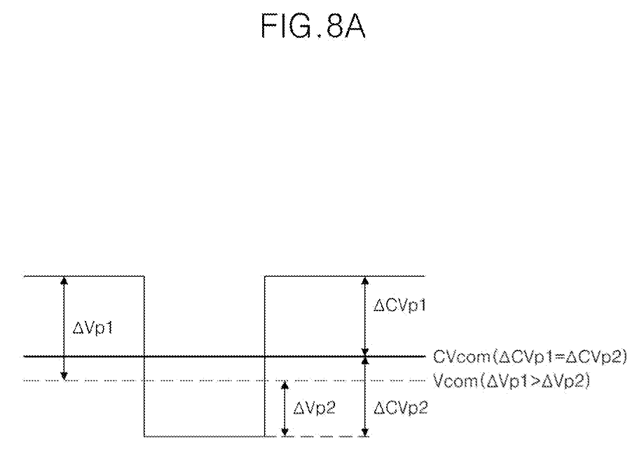

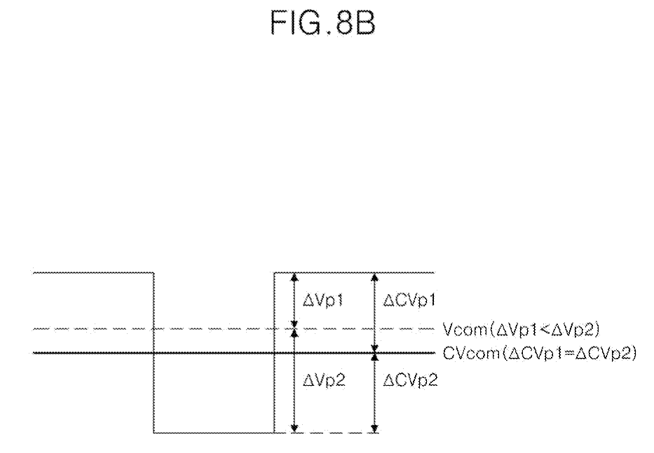

The VDD voltage is divided by a voltage divider circuit including the first resistor R1, the variable resistor VR and the second resistor R2 and applied to a noninverting (+) input terminal of the operational amplifier 128. If a resistance value of the variable resistor VR is changed, the compensating common voltage CVcom is adjusted. That is, as shown in FIG. 8A, if the first difference voltage ΔVp1 is higher than the second difference voltage ΔVp2, the variable resistor VR is adjusted to raise the compensating common voltage CVcom. Hence, the compensating common voltage generator 118 supplies the compensating common voltage of a relatively high level to the LCD panel 110.

As shown in FIG. 8B, if the first difference voltage ΔVp 1 is lower than the second difference voltage ΔVp2, the variable resistor VR is adjusted to lower the compensating common voltage CVcom. Hence, the compensating common voltage generator 118 supplies the compensating common voltage of a relatively low level to the LCD panel 110.

By this compensating common voltage CVcom, a difference ΔCVp1 between the compensating common voltage CVcom and the positive pixel voltage signal becomes equal to a difference ΔCVp2 between the compensating common voltage CVcom and the negative pixel voltage signal.

The operational amplifier 128 amplifies an input voltage Vin according to an amplifying ratio determined by third and fourth resistors R3 and R4. A DC or AC voltage is applied to an inverting (−) input terminal of the operational amplifier 128. According to this voltage, a voltage level or polarity of the compensating common voltage CVcom can vary.

The fifth resistor R5 and the capacitor C constitute an integrator to suppress the variation in the compensating common voltage CVcom by smoothing an output voltage of the operational amplifier 128.

As described previously, the LCD device in accordance with the first embodiment of the present invention generates a compensating common voltage of which common voltage level is adjusted depending on a feedback pixel voltage signal. Then differences between pixel voltage signals and a common voltage in an actual driving state generated by a kickback voltage can be minimized. Hence, deterioration in picture quality, that is, flicker or image sticking caused by the kickback voltage can be minimized by optimizing a common voltage according to an LCD panel.

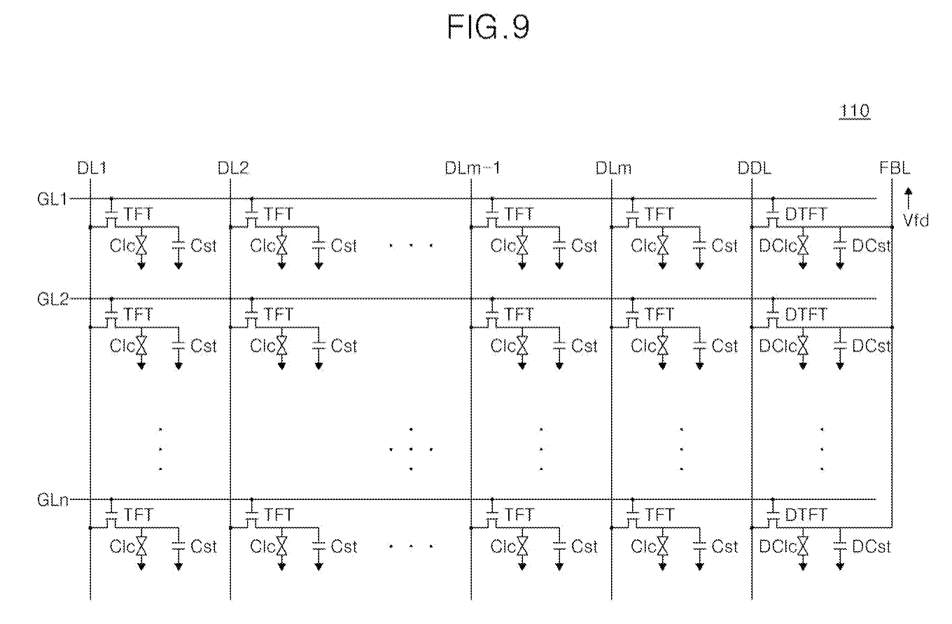

FIG. 9 is a circuit diagram illustrating an LCD panel of an LCD device according to a second embodiment of the present invention.

Referring to FIG. 9, the LCD panel of the LCD device has the same elements as the LCD panel shown in FIG. 4 except that dummy liquid crystal cells DClc, dummy thin film transistors DTFT and dummy storage capacitors DCst are additionally provided.

The dummy liquid crystal cells DClc are arranged in a matrix configuration at intersections of a dummy data line DDL and gate lines GLl to GLn. Dummy thin film transistors DTFT connected to the respective dummy liquid crystal cells DClc supply a pixel voltage signal received through the dummy data line DDL to the dummy liquid crystal cells DClc in response to a scan signal received from the gate line.

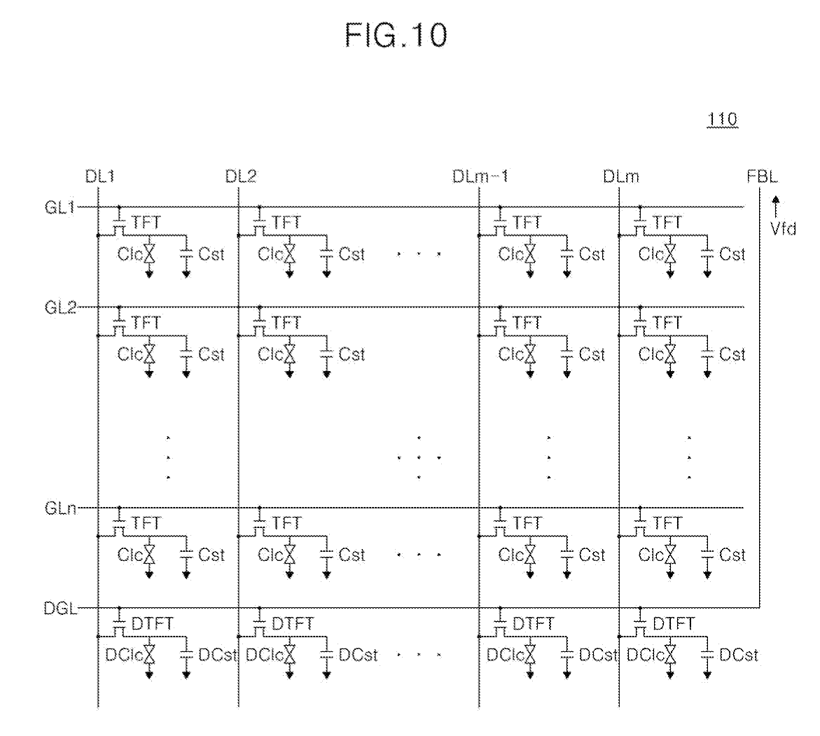

Alternatively, the dummy liquid crystal cells DClc are arranged in a matrix configuration at intersections of a dummy gate line DGL and the data lines DLl to DLm, as shown in FIG. 10. Dummy thin film transistors DTFT connected to the respective dummy liquid crystal cells DClc supply a pixel voltage signal received through the data line to the dummy liquid crystal cells DClc in response to a scan signal received from the dummy gate line DGL.

Meanwhile, dummy storage capacitors DCst are connected to the respective dummy liquid crystal cells DClc. The dummy storage capacitor DCst is formed between a pixel electrode of the dummy liquid crystal cell DClc and a preceding gate line, or between the pixel electrode of the dummy liquid crystal cell DClc and a dummy storage line, thereby maintaining a voltage charged to the dummy liquid crystal cell DClc at a constant level. The pixel voltage signal supplied to the dummy liquid crystal cell DClc is supplied to the comparator 120 through the feedback line FBL. The dummy liquid crystal cell DClc and the dummy thin film transistor DTFT are formed in a region overlapped with a black matrix.

Thus the LCD device in accordance with the second embodiment of the present invention generates a compensating common voltage of which common voltage level is adjusted depending on a pixel voltage signal. Therefore, differences between a common voltage and pixel voltage signals in an actual driving state generated by a kickback voltage can be minimized. Then deterioration in picture quality, that is, flicker or image sticking can be minimized by optimizing the common voltage according to an LCD panel.

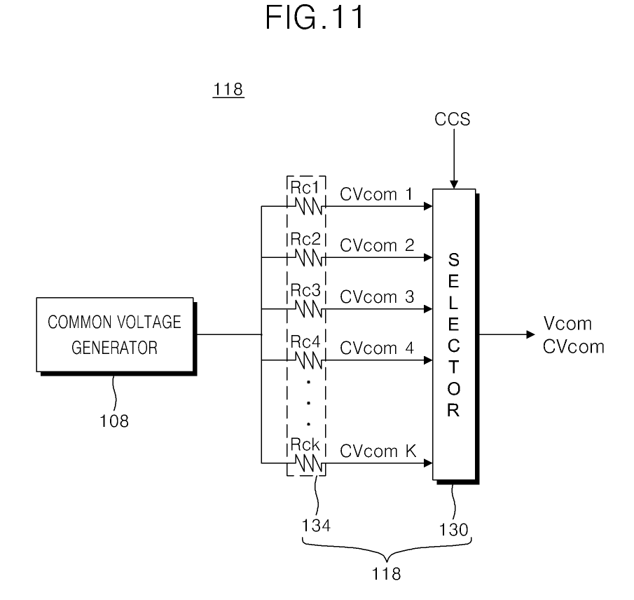

FIG. 11 is a circuit diagram illustrating a compensating common voltage generator of an LCD device according to a third embodiment of the present invention.

The LCD device shown in FIG. 11 has the same elements as the LCD device shown in FIG. 3 except that a resistor group connected to an output terminal of the compensating common voltage generator, and a selector are added. Therefore, a detailed description of the same elements will be omitted.

The compensating common voltage generator 118 includes a resistor group 134 connected to an output terminal of the common voltage generator 108 for generating a common voltage and includes a selector 130.

The resistor group 134 is connected to an output terminal of the common voltage generator 108 and includes a plurality of compensating resistors Rc1 to Rck having different resistances. This resistor group 134 receives the common voltage Vcom generated from the common voltage generator 108 and generates different compensating common voltages CVcoml to CVcomk to be supplied to the selector 130.

The selector 130 selects any one of the compensating common voltage CVcoml to CVcomk in response to a comparison control signal CCS generated from the comparator 120. For example, as shown in FIG. 8A, if the first difference voltage ΔVp1 is higher than the second difference voltage ΔAVp2, the selector 130 selects a compensating common voltage CVcom having a relatively high voltage level in response to the comparison control signal CCS. Meanwhile, as shown in FIG. 8B, if the first difference voltage ΔVp1 is less than the second difference voltage ΔVp2, the selector 130 selects a compensating common voltage CVcom having a relatively low voltage level in response to the comparison control signal CCS.

By this compensating common voltage CVcom, a difference ΔCVp1 between the compensating common voltage CVcom and the positive pixel voltage signal becomes equal to a difference ΔCVp2 between the compensating common voltage CVcom and the negative pixel voltage signal.

Thus the LCD device in accordance with the third embodiment of the present invention generates a compensating common voltage of which common voltage level is adjusted depending on a feedback pixel voltage signal. Therefore, differences between a common voltage and pixel voltage signals in an actual driving state generated by a kickback voltage can be minimized. Then deterioration in picture quality, that is, flicker or image sticking can be minimized by optimizing the common voltage according to an LCD panel.

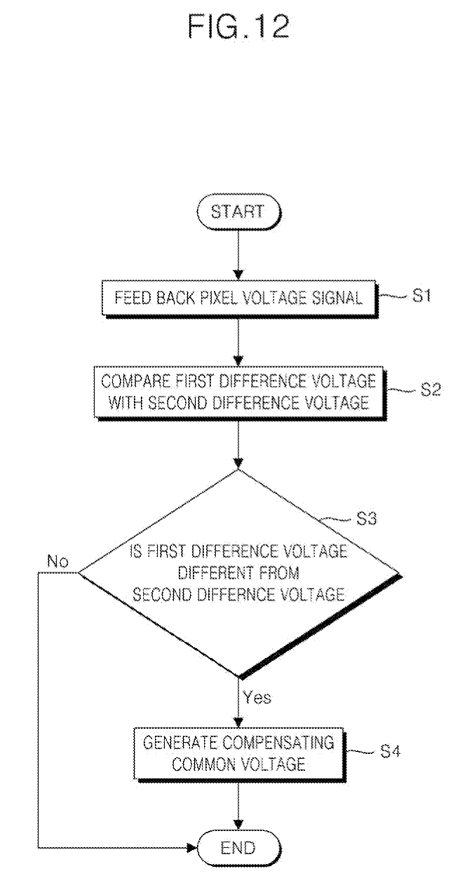

FIG. 12 is a flow chart of a driving method of an LCD device according to the present invention.

A pixel voltage signal charged to the liquid crystal cell through the feedback line is fed back to the comparator at step S1.

The comparator compares a first difference voltage between a positive pixel voltage signal which is fed back through the feedback line and a common voltage with a second difference voltage between a negative pixel voltage signal which is fed back through the feedback line and the common voltage at step S2.

If the first difference voltage is different from the second difference voltage, a compensating common voltage of which voltage level is adjusted is generated and supplied to the LCD panel at steps S3 and S4.

By this compensating common voltage, a difference between the compensating common voltage and the positive pixel voltage signal becomes equal to a difference between the compensating common voltage and the negative pixel voltage signal.

As described above, the inventive LCD device and driving method thereof generate a compensating common voltage of which common voltage level is adjusted according to a pixel voltage signal.

Therefore, differences between a common voltage and pixel voltage signals in an actual driving state generated by a kickback voltage can be minimized. Then deterioration in picture quality, that is, flicker or image sticking can be minimized by optimizing the common voltage according to an LCD panel.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A liquid crystal display device comprising:
a liquid crystal display panel having a plurality of liquid crystal cells to which a pixel voltage signal is supplied; and
a compensating common voltage generator for generating different compensating common voltages according to a pixel voltage signal which is fed back from the liquid crystal display panel.

2. The liquid crystal display device of claim 1, wherein the compensating common voltage generator generates different compensating common voltages according to a difference between a common voltage and a positive pixel voltage signal and a difference between the common voltage and a negative pixel voltage signal.

3. The liquid crystal display device of claim 2, further comprising a comparator for comparing a difference between the common voltage and the positive pixel voltage signal with a difference between the common voltage and the negative pixel voltage signal.

4. The liquid crystal display device of claim 1, wherein the liquid crystal display panel includes:
thin film transistors connected to the liquid crystal cells;
gate lines and data lines connected to the thin film transistors; and
a feedback line formed in parallel with at least the data lines or the gate lines, for feeding back a pixel voltage signal charged to the liquid crystal cells.

5. The liquid crystal display device of claim 1, wherein the liquid crystal display panel includes:
thin film transistors connected to the liquid crystal cells;
gate lines and data lines connected to the thin film transistors;
a dummy data line formed in parallel with the data lines;
dummy thin film transistors connected to the dummy data line and the gate lines;
dummy liquid crystal cells connected to the dummy thin film transistors; and
a feedback line for feeding back a pixel voltage signal charged to the dummy liquid crystal cells.

6. The liquid crystal display device of claim 1, wherein the liquid crystal display panel includes:
thin film transistors connected to the liquid crystal cells;
gate lines and data lines connected to the thin film transistors;
a dummy gate line formed in parallel with the gate lines;
dummy thin film transistors connected to the dummy gate line and the data lines;
dummy liquid crystal cells connected to the dummy thin film transistors; and
a feedback line for feeding back a pixel voltage signal charged to the dummy liquid crystal cells.

7. The liquid crystal display device of claim 5, wherein the dummy liquid crystal cells are overlapped with a black matrix.

8. The liquid crystal display device of claim 1, wherein the compensating common voltage generator includes:
a voltage divider for dividing a driving voltage, the voltage divider including first and second resistors connected between a driving voltage source and a ground voltage source and including a variable resistor for adjusting a level of the compensating common voltage, the voltage divider providing a divided driving voltage; and
an operational amplifier to which the divided driving voltage is applied.

9. The liquid crystal display device of claim 1, wherein the compensating common voltage generator includes:
a common voltage generator for generating a common voltage;
a resistor group having a plurality of resistors connected to the common voltage generator, the resistor group generating a plurality of compensating common voltages having different voltage levels; and
a selector for selecting one of the plurality of compensating common voltages.

10. The liquid crystal display device of claim 4, further comprising:
a gate integrated circuit for driving the gate lines; and
a data integrated circuit for driving the data lines.

11. The liquid crystal display device of claim 10, wherein the feedback pixel voltage signal is applied to the comparator through a dummy terminal of at least one of the gate integrated circuit and data integrated circuit.

12. The liquid crystal display device of claim 11, wherein the integrated circuits are packaged in one of a substrate of the liquid crystal display panel and tape carrier package.

13. The liquid crystal display device of claim 10, wherein the feedback pixel voltage signal is applied to the comparator through a dummy region of a tape carrier package in which at least one of the gate integrated circuit and data integrated circuit is packaged.

14. A method for driving a liquid crystal display device, comprising the steps of:
feeding back a pixel voltage signal supplied to a liquid crystal cell; and
generating different compensating common voltages according to the feedback pixel voltage signal.

15. The method of claim 14, wherein the step of generating different compensating common voltages includes generating different compensating common voltages according to a difference between a common voltage supplied to the liquid crystal cell and a positive pixel voltage signal and a difference between the common voltage and a negative pixel voltage signal.

16. The method of claim 15, wherein the step of feeding back a pixel voltage signal includes feeding back the pixel voltage signal through a feedback line formed in parallel with at least one of a data line and a gate line of a liquid crystal display panel.

17. The method of claim 15, wherein the step of feeding back a pixel voltage signal includes:
providing a liquid crystal display panel having gate lines, data lines crossing the gate lines, a dummy data line formed in parallel with the data lines, dummy thin film transistors connected to the dummy data line and the gate lines, dummy liquid crystal cells connected to the dummy thin film transistors, and a feedback line connected to pixel electrodes of the dummy liquid crystal cells; and
feeding back a pixel voltage signal charged to the dummy liquid crystal cells through the feedback line.

18. The method of claim 15, wherein the step of feeding back a pixel voltage signal includes:
providing a liquid crystal display panel having gate lines, data lines crossing the gate lines, a dummy gate line formed in parallel with the gate lines, dummy thin film transistors connected to the data lines and the dummy gate line, dummy liquid crystal cells connected to the dummy thin film transistors, and a feedback line connected to pixel electrodes of the dummy liquid crystal cells; and
feeding back a pixel voltage signal charged to the dummy liquid crystal cells through the feedback line.

19. The method of claim 15, wherein the step of generating different compensating common voltages includes:
dividing a driving voltage by using a voltage divider circuit; and
generating the compensating common voltages by applying the divided driving voltage to an operational amplifier,
wherein voltage levels of the compensating common voltages are adjusted by a variable resistor contained in the voltage divider circuit.

20. The method of claim 15, wherein the step of generating different compensating common voltages includes:
generating a common voltage by a common voltage generator;
generating compensating common voltages having different voltage levels by using a plurality of resistors connected to an output terminal of the common voltage generator; and
selecting any one of the compensating common voltages.

21. The method of claim 16, wherein the step of feeding back a pixel voltage signal includes feeding back the pixel voltage signal through a dummy terminal of an integrated circuit for driving at least ones of the gate lines and data lines.

22. The method of claim 21, wherein the step of feeding back a pixel voltage signal includes feeding back the pixel voltage signal through a dummy terminal of an integrated circuit packaged in any one of a substrate of the liquid crystal display panel and a tape carrier package.

23. The method of claim 16, wherein the step of feeding back a pixel voltage signal includes feeding back the pixel voltage signal through a dummy region of a tape carrier package in which an integrated circuit for driving at least ones of the gate lines and data lines is packaged.
